(19) United States
(12) Patent Application Publication
(10) Pub. No.: US 2024/0233998 A1
(43) Pub. Date: Jul. 11, 2024

(54) ELECTROMAGNET STRUCTURE ADOPTED IN VEHICLE LAMP

(71) Applicant: SONAR AUTO PARTS CO., LTD., NEW TAIPEI CITY (TW)

(72) Inventor: CHUNG-YI CHANG, Hsinchu County (TW)

(21) Appl. No.: 18/151,422

(22) Filed: Jan. 7, 2023

(51) Int. Cl. H01F 7/16; H01F 7/08

(52) U.S. Cl. CPC H01F 7/1607; H01F 7/081; B60Q 1/14

(57) ABSTRACT

An electromagnet structure adopted in a vehicle lamp is provided. The electromagnet structure can be disposed on a heat dissipating device of the vehicle lamp, and includes a housing, a coil seat, a coil, a movable iron core, and a push-pull rod. The coil seat is disposed in the housing, the coil is disposed on the coil seat, and the movable iron core is disposed in the coil seat. The push-pull rod is connected to the movable iron core, one end of the push-pull rod has a holding portion formed thereon that can hold one end of the driving rod. The electromagnet structure further includes a Zener diode that can provide a stable voltage and a connector that can transmit electrical power to the coil to drive movement of the movable iron core such that the push-pull rod synchronously drives the driving rod.

### FIELD OF THE DISCLOSURE

The present disclosure relates to an electromagnet structure, and more particularly to an electromagnet structure adopted in a vehicle lamp.

### BACKGROUND OF THE DISCLOSURE

Vehicles such as automobiles or motorcycles generally have low-beam and high-beam headlights disposed thereon. The headlight can switch between low-beam and high-beam modes by using a switching structure. The switching structure includes a light-shaping plate that is disposed in front of a light source, and the light-shaping plate can be driven by an electromagnet to change a reflected light of the light source to achieve switching between the low-beam and high-beam modes. However, the electromagnet adopted in the vehicle lamp requires a connecting mechanism for being connected to the light-shaping plate, thus causing an inconvenience in assembly. Conventionally, most vehicles lamps have issues relating to unstable voltage, such as to negatively affect the use safety of the vehicle lamps.

### SUMMARY OF THE DISCLOSURE

In response to the above-referenced technical inadequacies, the present disclosure provides an electromagnet structure adopted in a vehicle lamp. The electromagnet structure can provide a stable voltage to improve the safety in using the vehicle, and enable an assembly process to be simpler and easier.

In one aspect, the present disclosure provides an electromagnet structure adopted in a vehicle lamp. The vehicle lamp includes a driving rod.

The electromagnet structure includes a housing, a coil seat, a coil, a movable iron core, a push-pull rod, a connector, and a Zener diode. The coil seat is disposed in the housing. The coil is disposed on the coil seat. The movable iron core is disposed in the coil seat, and the movable iron core is located in the coil. The push-pull rod is connected to the movable iron core, and one end of the push-pull rod has a holding portion formed thereon that can hold one end of the driving rod. The connector is disposed on one side of the housing. The Zener diode is electrically connected between the coil and the connector and capable of providing a stable voltage. The connector is able to transmit electrical power to the coil through the Zener diode to drive the movable iron core to move and promote the push-pull rod to synchronously drive the driving rod, so that the vehicle lamp is switched between a high-beam mode and a low-beam mode.

Therefore, in the electromagnet structure adopted in the vehicle lamp provided in the present disclosure, the electromagnet structure includes a housing, a coil seat, a coil, a movable iron core, a push-pull rod, a connector, and a Zener diode. The coil seat is disposed in the housing. The coil is disposed on the coil seat. The movable iron core is disposed in the coil seat, and the movable iron core is located in the coil. The push-pull rod is connected to the movable iron core, and one end of the push-pull rod has a holding portion formed thereon that can hold one end of the driving rod. The connector is disposed on one side of the housing. The Zener diode is electrically connected between the coil and the connector. The connector is able to transmit electrical power to the coil through the Zener diode to drive the movable iron core to move and promote the push-pull rod to synchronously drive the driving rod, so that the vehicle lamp is switched between a high-beam mode and a low-beam mode. The Zener diode can provide a stable voltage to prevent damage from being inflicted to the vehicle lamp, so as to improve a safety when using the vehicle lamp. Moreover, the push-pull rod uses the holding portion to hold the one end of the driving rod, so that the assembly process becomes simpler and easier.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic perspective view of an electromagnet structure adopted in a vehicle lamp of the present disclosure;

FIG. 2 is another schematic perspective view of the electromagnet structure of the present disclosure;

FIG. 3 is a cross-sectional view taken along line III-III of FIG. 1;

FIG. 4 is a schematic exploded perspective view of the electromagnet structure of the present disclosure;

FIG. 5 is a schematic exploded perspective view of a Zener diode and a connector of the present disclosure;

FIG. 6 is a schematic perspective view of the Zener diode and the connector of the present disclosure; and

FIG. 7 is a schematic view of the electromagnet structure of the present disclosure being mounted on a heat dissipating device of the vehicle lamp.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### [EMBODIMENT]

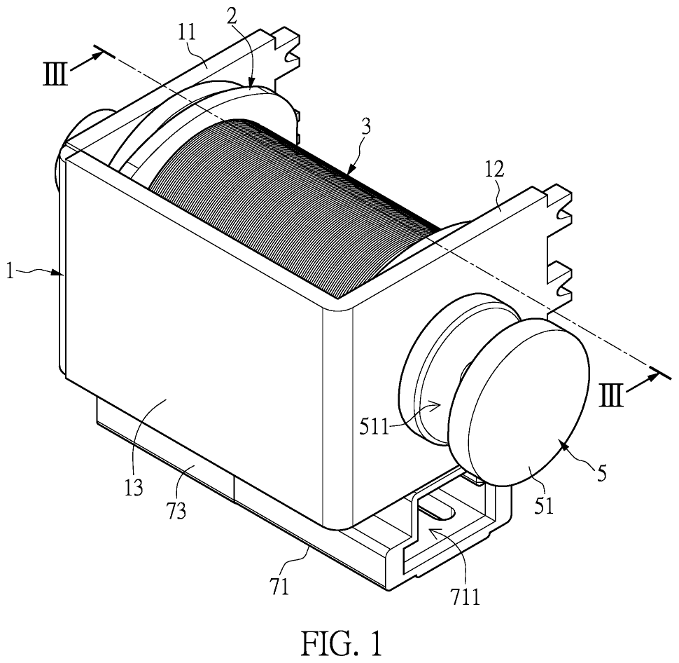

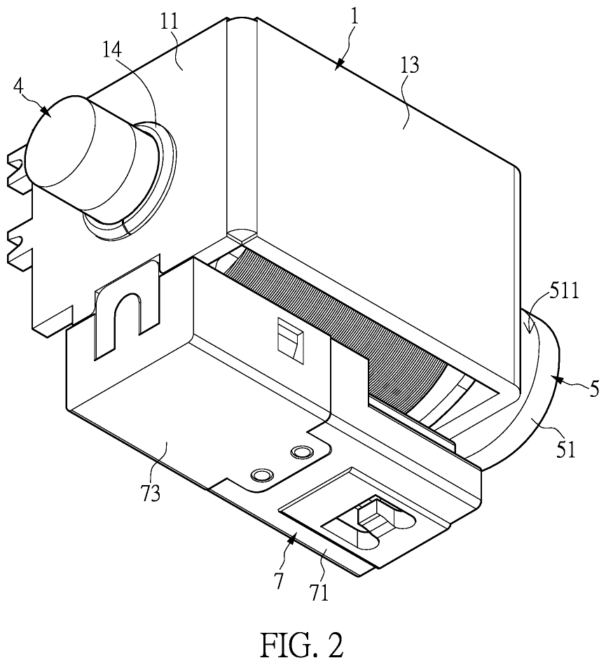

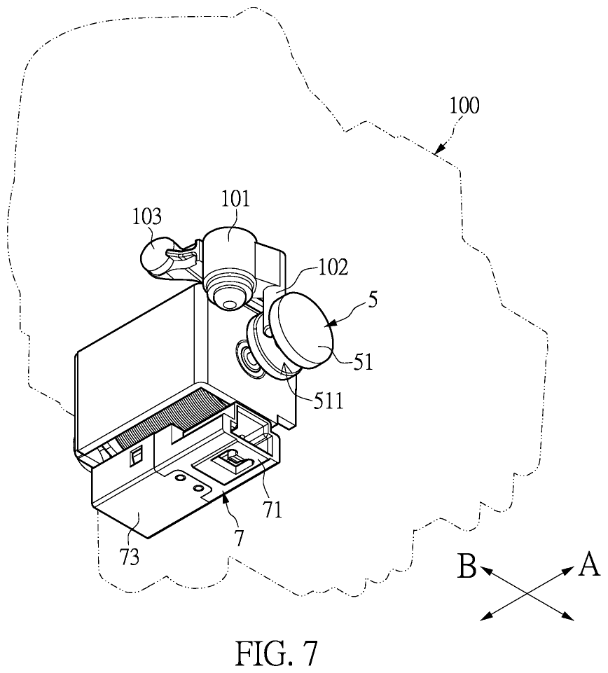

Referring to FIG. 1 to FIG. 4, the present disclosure provides an electromagnet structure adopted in a vehicle lamp. The electromagnet structure can be disposed on a heat dissipating device 100 (as shown in FIG. 7) of the vehicle lamp, and includes a housing 1, a coil seat 2, a coil 3, a movable iron core 4, and a push-pull rod 5.

The housing 1 is a hollow housing, and the housing 1 can have a first end plate 11, a second end plate 12, and a connection plate 13, the first end plate 11 and the second end plate 12 are connected to two ends of the connection plate 13 that are opposite to each other. The first end plate 11 and the second end plate 12 can be parallel to each other. The coil seat 2 is disposed in the housing 1, and the coil seat 2 can be disposed between the first end plate 11 and the second end plate 12, so that the coil seat 2 can be stably disposed between the first end plate 11 and the second end plate 12. The coil 3 is disposed on the coil seat 2, and the movable iron core 4 is disposed in the coil seat 2, in which the movable iron core 4 is located in the coil 3.

The push-pull rod 5 is connected to the movable iron core 4, one end of the push-pull rod 5 has a holding portion 51 formed thereon, and the holding portion 51 is able to hold one end of the driving rod 101. Preferably, the holding portion 51 is circular, an annular slot 511 is formed in the holding portion 51 and is annularly formed on the holding portion 51, so that one end of the driving rod 101 (as shown in FIG. 7) can be easily and correspondingly arranged in the annular slot 511, so as to achieve rapid assembly. When the coil 3 is powered on and generates magnetic force via excitation, movement of the movable iron core 4 is affected by a magnetic loop such that the push-pull rod 5 synchronously drives the driving rod 101, so that the vehicle lamp is switched between a high-beam mode and a low-beam mode.

When the electromagnet structure is activated, the push-pull rod 5 can drive a light-shaping plate (omitted in the figures) through the driving rod 101 to operate and switch between the high-beam mode and the low-beam mode. The driving rod 101 is pivotally connected to the vehicle lamp, and the driving rod can have an active end 102 and a slave end 103. The holding portion 51 of the push-pull rod 5 holds the active end 102 of the driving rod 101, so that the active end 102 is provided in the annular slot 511. The active end 102 can move along a left-right direction A (as shown in FIG. 7), and the slave end 103 can move along a front-rear direction B; that is, the active end 102 can be pushed by the push-pull rod 5 of the electromagnet structure and move along the left-right direction A, and the slave end 103 can move along the front-rear direction B to push the light-shaping plate (omitted in the figures), so that the push-pull rod 5 of the electromagnet structure drives the light-shaping plate through the driving rod 101 and the vehicle lamp is switched between the high-beam mode and the low-beam mode. In addition, a power transmission direction of the electromagnet and the light-shaping plate can be changed, so that the arrangement of the electromagnet and the light-shaping plate can be more flexible. Furthermore, the electromagnet structure can be horizontally arranged in front of the heat dissipating device 100 to save an occupied space and lower an overall height of the electromagnet structure.

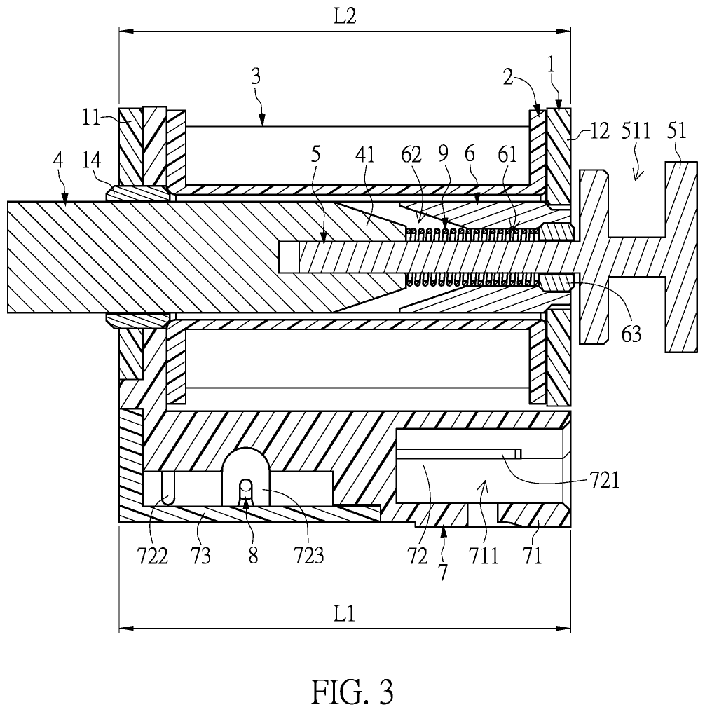

In this embodiment, a guiding seat 6 is disposed in the coil seat 2, the guiding seat 6 is arranged at a positon on the coil seat 2 that is adjacent to the holding portion 51 of the push-pull rod 5, and a through hole 61 and a conical hole 62 are formed in the guiding seat 6 (as shown in FIG. 3). One end of the through hole 61 is connected with one end of the conical hole 62, another end of the through hole 61 penetrates to one end of the guiding seat 6, and another end of the conical hole 62 penetrates to another end of the guiding seat 6. The push-pull rod 5 penetrates through the guiding seat 6, and the push-pull rod 5 penetrates through the through hole 61 and conical hole 62 of the guiding seat 6. The conical hole 62 is arranged at a position on the guiding seat 6 that is adjacent to the movable iron core 4, and a diameter of the conical hole 62 is increased along a direction toward the movable iron core 4. One end of the movable iron core 4 has a conical portion 41 formed thereon, the conical portion 41 is adjacent to the guiding seat 6, and a diameter of the conical portion 41 is decreased along a direction toward the guiding seat 6, so that the conical portion 41 has a taper that matches with a taper of the conical hole 62. When the movable iron core 4 is moved by the effect of the magnetic loop, the conical portion 41 can cooperate with the conical hole 62 to guide the movable iron core 4 and the push-pull rod 5 to stably perform linear movement. Furthermore, a recovery spring 9 can be disposed between the movable iron core 4 and the guiding seat 6, and the recovery spring 9 can push the movable iron core 4 and the push-pull rod 5 to move and return to their original positions.

In this embodiment, a rear bearing 14 is disposed between the movable iron core 4 and the first end plate 11 of the housing 1, so that the movable iron core 4 is supported and guided to move more stably and smoothly. Furthermore, a front bearing 63 is disposed between the push-pull rod 5 and the guiding seat 6, so that the push-pull rod 5 is supported and guided to move more stably and smoothly.

The electromagnet structure further includes a connector 7 and a Zener diode 8, and the connector 7 and the Zener diode 8 are disposed on one side (a bottom side) of the housing 1. The Zener diode is electrically connected between the coil 3 and the connector 7, and the connector 7 can transmit electrical power to the coil 3 and the Zener diode 8 can provide a stable voltage. The connector 7 transmits electrical power to the coil 3 to drive movement of the movable iron core 4 such that the push-pull rod 5 synchronously drives the driving rod 101, so that the vehicle lamp is switched between the high-beam mode and the low-beam mode.

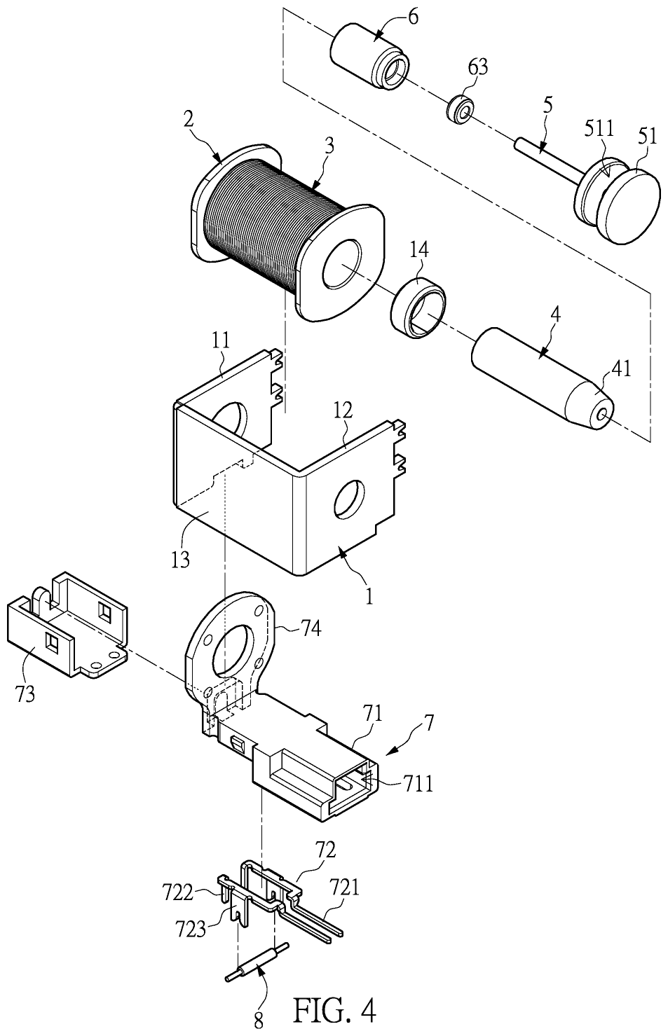

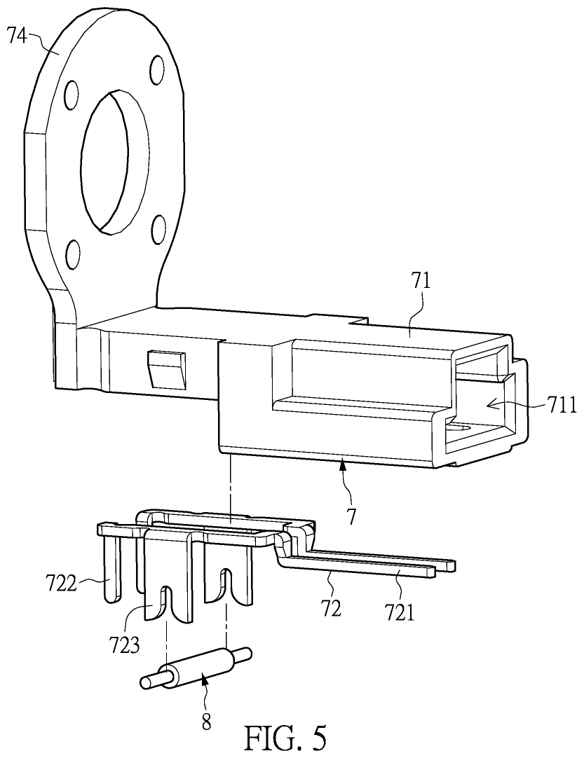

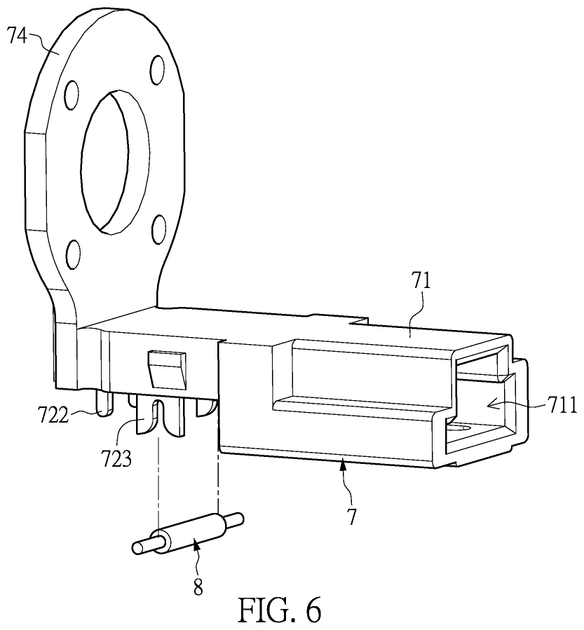

Reference is made to FIG. 4 to FIG. 6, in which the connector 7 includes an insulation body 71 and at least two terminals 72. The insulation body 71 is made of an insulation material such as plastics, and the terminals 72 are made of metal materials having good electrical conductivity, such as copper. The insulation body 71 has a slot 711, and the terminals 72 are disposed on the insulation body 71. Each of the terminals 72 has a first end 721 and a second end 722, the first end 721 and the second end 722 are located at two opposite ends of the terminal 72, and a receiving portion 723 is disposed between the first end 721 and the second end 722. The first ends 721 of the terminals 72 extend into the slot 711 of the insulation body 71 to be in contact with terminals of a corresponding connector (omitted in the figures) and receive the electrical power that is required. The second ends 722 and the receiving portions 723 of the terminals 72 extend out of the insulation body 71, that is, the second ends 722 and the receiving portions 723 of the terminals 72 can extend out from one side (a bottom side) of the insulation body 71. The receiving portions 723 of the terminals 72 allow the Zener diode 8 to be plugged therein, and the second ends 722 of the terminals 72 can be electrically connected to the coil 3, so that the Zener diode 8 is electrically connected between the connector 7 and the coil 3 to provide a stable voltage. The connector 7 can be used to input electrical power, and can allow the Zener diode 8 to be plugged therein.

An external side of the insulation body 71 is engaged to a cover 73 that is covered outside the Zener diode 8, and the second ends 722 and the receiving portions 723 of the terminals 72, so as to protect the Zener diode 8. Preferably, one end of the insulation body 71 is extended to have a fixing plate 74 formed thereon, and the fixing plate 74 can be sandwiched between the housing 1 and the coil seat 2. That is, the fixing plate 74 can be held between the first end plate 11 of the housing 1 and the coil seat 2, so that the Zener diode 8 and the connector 7 can be stably disposed on one side of the housing 1, and an assembly process thereof is simple and easy. Preferably, a length L1 (as shown in FIG. 3) of the insulation body 71 and the cover 73 is not greater than a length L2 of the housing 1; that is, the length L1 of the insulation body 71 and the cover 73 is equal to or less than the length L2 of the housing 1, so as to not occupy excessive space.

### [Beneficial Effects of the Embodiment]

In conclusion, in the electromagnet structure adopted in the vehicle lamp provided in the present disclosure, the electromagnet structure includes a housing, a coil seat, a coil, a movable iron core, a push-pull rod, a connector, and a Zener diode. The coil seat is disposed in the housing. The coil is disposed on the coil seat. The movable iron core is disposed in the coil seat, and the movable iron core is located in the coil. The push-pull rod is connected to the movable iron core, and one end of the push-pull rod has a holding portion formed thereon that can hold one end of the driving rod. The connector is disposed on one side of the housing. The Zener diode is electrically connected between the coil and the connector. The connector is able to transmit electrical power to the coil through the Zener diode to drive movement of the movable iron core such that the push-pull rod synchronously drives the driving rod, so that the vehicle lamp is switched between a high-beam mode and a low-beam mode. The Zener diode can provide a stable voltage to prevent damage from being inflicted to the vehicle lamp, so as to improve a safety when using the vehicle lamp. Moreover, the push-pull rod uses the holding portion to hold the one end of the driving rod, so that the assembly process becomes simpler and easier.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An electromagnet structure adopted in a vehicle lamp that includes a driving rod, and the electromagnet structure comprising:
a housing;
a coil seat disposed in the housing;
a coil disposed on the coil seat;
a movable iron core disposed in the coil seat, wherein the movable iron core is located in the coil;
a push-pull rod connected to the movable iron core, wherein one end of the push-pull rod has a holding portion formed thereon, and the holding portion is able to hold one end of the driving rod;
a connector disposed on one side of the housing; and
a Zener diode electrically connected between the coil and the connector and capable of providing a stable voltage;
wherein the connector is able to transmit electrical power to the coil through the Zener diode to drive movement of the movable iron core such that the push-pull rod synchronously drives the driving rod, so that the vehicle lamp is switched between a high-beam mode and a low-beam mode.

2. The electromagnet structure according to claim 1, wherein the connector includes an insulation body and at least two terminals, the insulation body has a slot, and the at least two terminals are disposed on the insulation body; wherein each of the at least two terminals has a first end and a second end, and a receiving portion is disposed between the first end and the second end; wherein the first ends of the at least two terminals extend into the slot of the insulation body, the second ends and the receiving portions of the at least two terminals extend out of the insulation body, the receiving portions of the at least two terminals allow the Zener diode to be plugged therein, and the second ends of the at least two terminals are electrically connected to the coil.

3. The electromagnet structure according to claim 2, wherein an external side of the insulation body is engaged to a cover that is covered outside the Zener diode, and the second ends and the receiving portions of the terminals.

4. The electromagnet structure according to claim 3, wherein a length of the insulation body and the cover is equal to or less than a length of the housing.

5. The electromagnet structure according to claim 2, wherein one end of the insulation body is extended to have a fixing plate formed thereon, and the fixing plate is held between the housing and the coil seat.

6. The electromagnet structure according to claim 1, wherein the housing has a first end plate, a second end plate, and a connection plate, the first end plate and the second end plate are connected to two ends of the connection plate that are opposite to each other, and the coil seat is disposed between the first end plate and the second end plate; wherein a rear bearing is disposed between the movable iron core and the first end plate of the housing.

7. The electromagnet structure according to claim 1, wherein a guiding seat is disposed in the coil seat, the guiding seat is arranged at a positon on the coil seat that is adjacent to the holding portion of the push-pull rod, and a through hole and a conical hole are formed in the guiding seat; wherein the push-pull rod penetrates through the through hole and conical hole, the conical hole is arranged at a position on the guiding seat that is adjacent to the movable iron core, and a diameter of the conical hole is increased along a direction toward the movable iron core; wherein one end of the movable iron core has a conical portion formed thereon, the conical portion is adjacent to the guiding seat, and a diameter of the conical portion is decreased along a direction toward the guiding seat, so that the conical portion has a taper that matches with a taper of the conical hole.

8. The electromagnet structure according to claim 7, wherein a front bearing is disposed between the push-pull rod and the guiding seat.

9. The electromagnet structure according to claim 1, wherein the holding portion is circular, an annular slot is formed in the holding portion and is annularly formed on the holding portion, and one end of the driving rod is correspondingly arranged in the annular slot.

10. The electromagnet structure according to claim 1, wherein the driving rod is pivotally connected to the vehicle lamp, and the driving rod has an active end and a slave end; wherein the holding portion holds the active end of the driving rod, the active end is able move along a left-right direction, and the slave end is able move along a front-rear direction, so that the vehicle lamp is switched between the high-beam mode and the low-beam mode.
